(19) United States
(12) Patent Application Publication
(10) Pub. No.: US 2022/0147885 A1
(43) Pub. Date: May 12, 2022

(54) TOUR PLAN GENERATION APPARATUS, TOUR PLAN GENERATION METHOD, AND NON-TRANSITORY COMPUTER READABLE MEDIUM

(71) Applicant: NEC Corporation, Tokyo (JP)

(72) Inventors: Takuya Kuwahara, Tokyo (JP); Kozo Satoda, Tokyo (JP); Takayuki Kuroda, Tokyo (JP); Yutaka Yakuwa, Tokyo (JP); Tatsuya Fukuda, Tokyo (JP); Takashi Maruyama, Tokyo (JP); Kazuki Tanabe, Tokyo (JP)

(73) Assignee: NEC Corporation, Tokyo (JP)

(21) Appl. No.: 17/517,237

(22) Filed: Nov. 2, 2021

(30) Foreign Application Priority Data
Nov. 6, 2020 (JP) 2020-185570

(51) Int. Cl. G06Q 10/02; G06Q 50/14

(52) U.S. Cl. CPC G06Q 10/025; G06Q 50/14

(57) ABSTRACT

A tour plan generation apparatus according to the present disclosure includes an input unit configured to receive inputs of a tour request and a condition for a package tour, a concretizing unit configured to generate, as a tour plan, a concretized tour request by concretizing the input tour request and the condition, the concretized tour request being a request that satisfies the concretized condition, and an output unit configured to output the generated tour plan.

### INCORPORATION BY REFERENCE

This application is based upon and claims the benefit of priority from Japanese patent application No. 2020-185570, filed on Nov. 6, 2020, the disclosure of which is incorporated herein in its entirety by reference.

### TECHNICAL FIELD

The present disclosure relates to a tour plan generation apparatus, a tour plan generation method, and a non-transitory computer readable medium for generating a tour plan for a package tour.

### BACKGROUND ART

Conventionally, a tour plan for a package tour is generated on a tour-by-tour basis by a clerk of a travel agency who asks a customer about various procedures necessary for his/her travel (i.e., about arrangements for transportation (i.e., means for moving), accommodations, sightseeing of famous places, visits to events, and the like). Therefore, there has been a problem that it is impossible to promptly propose a tour plan to a customer.

Therefore, recently, a technology for automatically generating a tour plan for a package tour has been proposed (e.g., Japanese Unexamined Patent Application Publication No. 2003-044553).

The technology disclosed in Japanese Unexamined Patent Application Publication No. 2003-044553 includes, in addition to an accommodation database and a database on facilities (food and drink, and sightseeing), a travel model template database in which travel model template data, which serves as templates for travel plans, are registered. When a travel plan is generated, it is generated by retrieving travel model template data from the travel model template database, and extracting an accommodation(es) or the like that satisfies conditions for the travel from the accommodation database or the like.

However, there is problem, in the technology disclosed in Japanese Unexamined Patent Application Publication No. 2003-044553, that since a travel plan is generated by using travel model template data, it can generate only a travel plan that conforms to the template and thus it cannot generate a flexible travel plan that satisfies customer's requests.

### SUMMARY

Therefore, an example object of the present disclosure is to solve the above-described problem and thereby to provide a tour plan generation apparatus, a tour plan generation method, and a non-transitory computer readable medium capable of generating a flexible tour plan that satisfies customer's requests.

In a first example aspect, a tour plan generation apparatus includes:

an input unit configured to receive inputs of a tour request and a condition for a package tour;

a concretizing unit configured to generate, as a tour plan, a concretized tour request by concretizing the input tour request and the condition, the concretized tour request being a request that satisfies the concretized condition; and

an output unit configured to output the generated tour plan.

In another example aspect, a tour plan generation method is a tour plan generation method performed by a tour plan generation apparatus, including:

receiving inputs of a tour request and a condition for a package tour;

generating, as a tour plan, a concretized tour request by concretizing the input tour request and the condition, the concretized tour request being a request that satisfies the concretized condition; and

outputting the generated tour plan.

In another example aspect, a non-transitory computer readable medium is a non-transitory computer readable medium storing a program causes a computer to perform:

a process for receiving inputs of a tour request and a condition for a package tour;

a process for generating, as a tour plan, a concretized tour request by concretizing the input tour request and the condition, the concretized tour request being a request that satisfies the concretized condition; and

a process for outputting the generated tour plan.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 shows an example of a configuration of a tour plan generation apparatus according to a first example embodiment;

FIG. 2 shows examples of conceptual data structures of tour items;

FIG. 3 shows an example of a conceptual data structure of a tour request;

FIG. 4 shows an example of a conceptual data structure of conditions associated with the tour request shown in FIG. 3;

FIG. 5 shows an example of a conceptual data structure of a concretizing pattern according to a specific example 1;

FIG. 6 shows examples of conceptual data structures of left and right sides of a concretizing pattern according to a specific example 2;

FIG. 7 shows an example of a conceptual data structure of a template of a concretizing pattern according to the specific example 2;

FIG. 8 shows an example of a conceptual data structure of a tour request that is obtained by concretizing the tour request shown in FIG. 3 based on the concretizing pattern according to the specific example 2 shown in FIGS. 6 and 7;

FIG. 9 shows an example of a conceptual data structure of conditions that is obtained by concretizing the conditions shown in FIG. 4 based on the concretizing pattern according to the specific example 2 shown in FIGS. 6 and 7;

FIG. 10 shows examples of conceptual data structures of left and right sides of a concretizing pattern according to a specific example 3;

FIG. 11 is a diagram for explaining an example of operations of a tour item registration database according to a first example embodiment;

FIG. 12 shows an example of a conceptual data structure (1/3) of a tour plan that is generated by concretizing the tour request shown in FIG. 3;

FIG. 13 shows an example of a conceptual data structure (2/3) of the tour plan that is generated by concretizing the tour request shown in FIG. 3;

FIG. 14 shows an example of a conceptual data structure (3/3) of the tour plan that is generated by concretizing the tour request shown in FIG. 3;

FIG. 15 shows an example of an input window and an output window displayed on a display of a terminal according to a first example embodiment;

FIG. 16 is a flowchart for explaining an example of a flow of operations performed by a tour plan generation apparatus according to the first example embodiment;

FIG. 17 shows an example of a configuration of a tour plan generation apparatus according to a second example embodiment;

FIG. 18 shows an example of a current tour plan for which a modifying process is performed, and a current tour request based on which the current tour plan has been generated;

FIG. 19 shows an example of a current tour plan, and a modified tour request which has been modified based on tour items of the current tour plan that have not yet been carried out;

FIG. 20 shows an example of a modified tour request, and a modified tour plan that has been generated based on the modified tour request;

FIG. 21 shows an example of a current tour request, and a re-generated tour plan that has been generated based on the current tour request;

FIG. 22 shows an example of an input window and an output window displayed on a display of a terminal according to a second example embodiment;

FIG. 23 shows an example of a configuration of a tour plan generation apparatus according to a third example embodiment; and

FIG. 24 shows an example of a hardware configuration of a tour plan generation apparatus according to a fourth example embodiment.

### EXAMPLE EMBODIMENT

Example embodiments according to the present disclosure will be described hereinafter with reference to the drawings. Note that, for clarifying the explanation, the following descriptions and the drawings are partially omitted and simplified as appropriate. Further, the same symbols are assigned to the same elements throughout the drawings, and redundant explanations are omitted as appropriate.

### First Example Embodiment

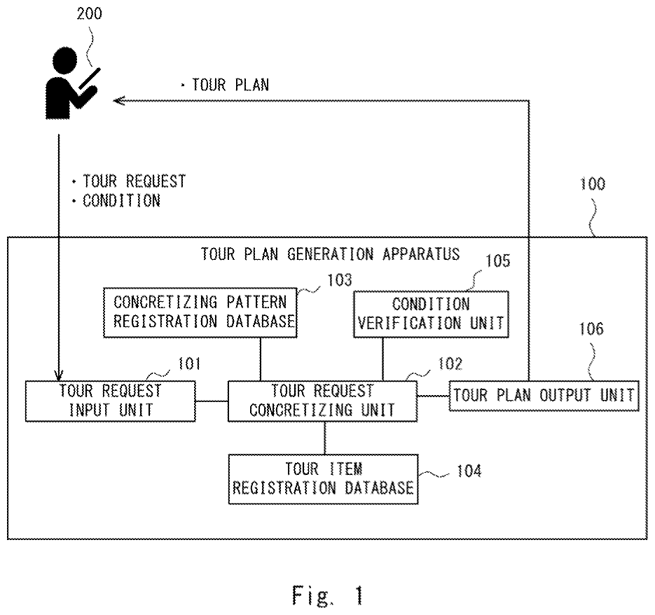

Firstly, an example of a configuration of a tour plan generation apparatus 100 according to a first example embodiment will be described. FIG. 1 shows an example of the configuration of the tour plan generation apparatus 100 according to the first example embodiment. As shown in FIG. 1, the tour plan generation apparatus 100 according to the first example embodiment includes a tour request input unit 101, a tour request concretizing unit 102, a concretizing pattern registration database 103, a tour item registration database 104, a condition verification unit 105, and a tour plan output unit 106. Note that a terminal 200 shown in FIG. 1 is a terminal used by a customer, and it should have at least an input function, a communication function, and a display function. Further, although the terminal 200 shown in FIG. 1 is a portable terminal that can be carried by a customer, the terminal may instead be a stationary-type fixed terminal.

The tour request input unit 101 receives inputs of a tour request and conditions for a package tour desired by a customer from the terminal 200. The tour request includes at least one tour item.

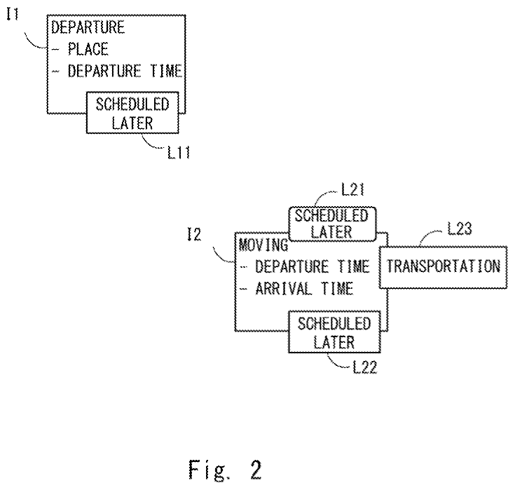

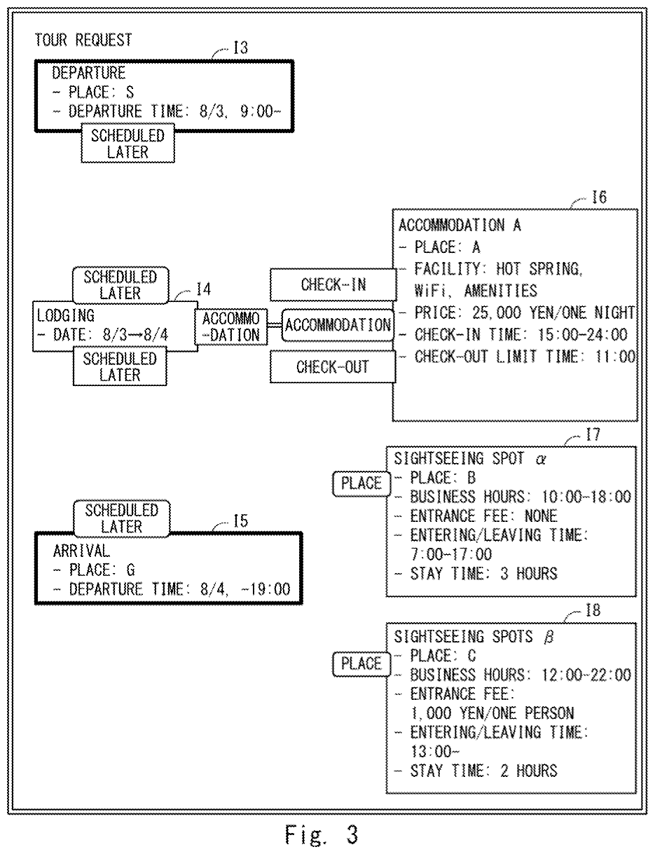

FIG. 2 shows examples of conceptual data structures of tour items. However, FIG. 2 can be considered to be a diagram for showing an example of a UI displayed on the terminal 200. (The same applies to FIGS. 3 to 10 and FIGS. 12 to 14 described later.) Note that UI stands for a user interface. FIG. 2 shows, as examples, a tour item I1 for “Departure” and a tour item I2 for “Moving”. A label L11 for “Scheduled Later” is added to the tour item I1 for “Departure”. Further, a label L21 for “Scheduled Later”, a label L22 for “Scheduled Later”, and a label L23 for “Transportation” are added to the tour item I2 for “Moving”. Among these labels, the angular rectangle label L11 is a request related to the tour item I1, and the angular rectangle labels L22 and L23 are requests related to tour item I2. Further, these angular rectangle labels L11, L22 and L23 indicate that they need to be associated with rounded rectangle labels of other tour items. For example, the angular rectangle label L11 for “Scheduled Later” of the tour item I1 for “Departure” can be associated with the rounded rectangle label L21 for “Scheduled Later” of the tour item I2 for “Moving”.

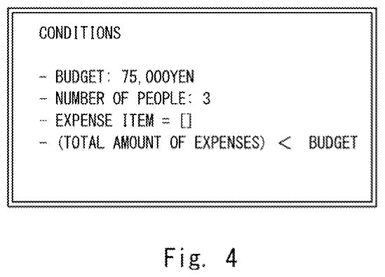

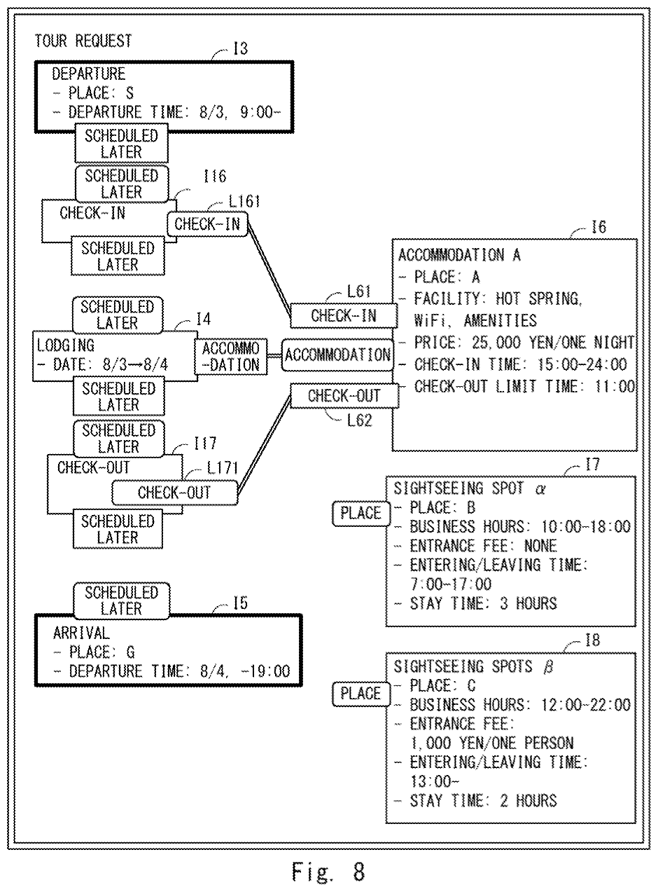

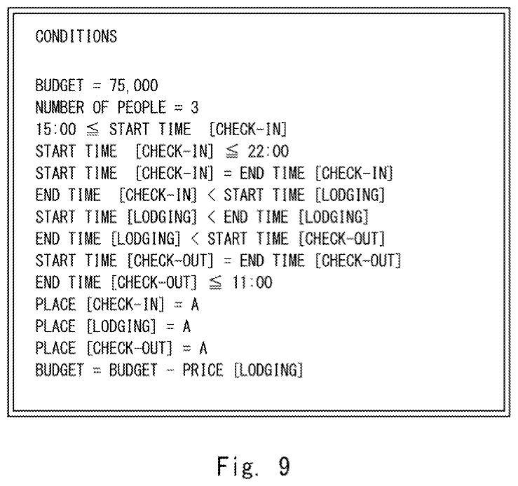

FIG. 3 shows an example of a conceptual data structure of a tour request, and FIG. 4 shows an example of a conceptual data structure of conditions. Note that FIGS. 3 and 4 are shown as separate drawings for the sake of convenience, but the tour request shown in FIG. 3 and the conditions shown in FIG. 4 are associated with each other, and are input from the terminal 200 in the form of a pair. Further, in FIGS. 3 and 4, the double-line rectangular frames indicate that the tour request and the conditions are shown inside the frames. (The same applies to FIGS. 8 and 9 described later.)

The tour request shown in FIG. 3 is an example in the case where a customer roughly desires as follows.
Depart from a departure place S at 9 o'clock on August 3.
Stay overnight in an accommodation A.
Visit sightseeing spots α and β.
Arrive at a destination place G at 19 o'clock on August 4th.

Therefore, the tour request shown in FIG. 3 includes a tour item I3 for “Departure”, a tour item I4 for “Lodging”, a tour item I5 for “Arrival”, a tour item I6 for “Accommodation A”, a tour item I7 for “Sightseeing Spot α”, and a tour item I8 for “Sightseeing Spot β”.

The conditions shown in FIG. 4 are roughly as follows.
Budget is 75,000 yen.
The number of people is three.
The total amount of expenses should be less than the budget. Note that the expense items have not yet been determined at this stage.

In the tour request shown in FIG. 3, there are a lot of items and the like, such as transportation and time schedules, that have not yet been determined. Further, in the conditions shown in FIG. 4, there are also a lot of items and the like, such as expense items, that have not yet been determined.

Therefore, the tour request concretizing unit 102 concretizes (i.e., determines in a detailed manner) the undetermined items and the like in the tour request and those in the conditions through an automatic generation process using a concretizing process.

Specifically, the tour request concretizing unit 102 concretizes the undetermined items and the like in the tour request and those in the conditions based on a concretizing pattern, which is a pattern for concretizing the tour request and the conditions and is registered in the concretizing pattern registration database 103.

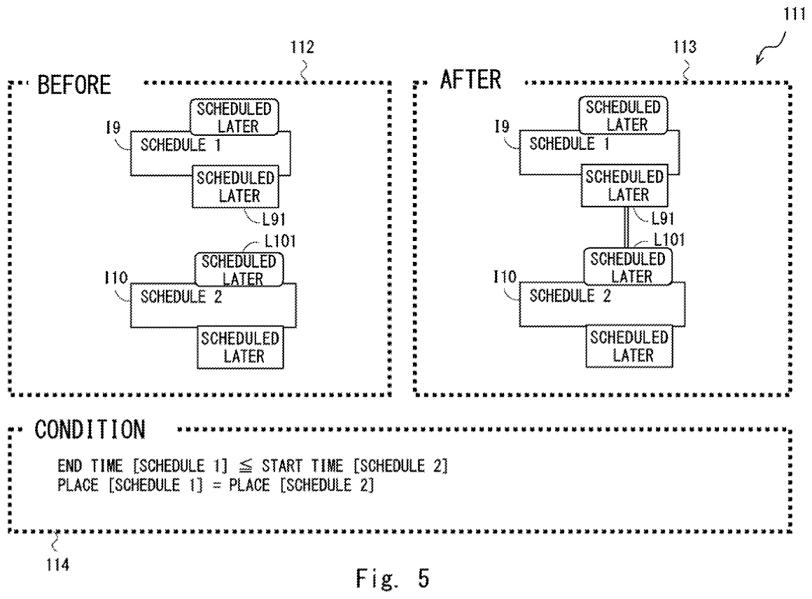

A concretizing pattern will be described hereinafter. FIG. 5 shows an example of a conceptual data structure of a concretizing pattern 111 according to a specific example 1. As shown in FIG. 5, the concretizing pattern 111 includes information indicating items to be concretized (hereinafter referred to as a left side of the concretizing pattern) 112, information indicating a structure after the concretization (hereinafter referred to as a right side of the concretizing pattern) 113, and a template 114 for generating a condition that is added by the concretization.

When a structure corresponding to the left side 112 of the concretizing pattern is included in the tour request, the tour request concretizing unit 102 rewrites that structure into a structure corresponding to the right side 113 of the concretizing pattern. After this rewriting, the tour request concretizing unit 102 adds a condition generated by the template 114 in the conditions associated with the tour request.

In the concretizing pattern 111 according to the specific example 1 shown in FIG. 5, the data structure before the rewriting and that after the rewriting are as follows.

### Data Structure Before Rewriting:

A tour item I9 for “Schedule 1” and a tour item I10 for “Schedule 2” are disposed independently of each other.

### Data Structure After Rewriting:

A label L91 for “Scheduled Later” of the tour item I9 for “Schedule 1” is associated with a label L101 for “Scheduled Later” of the tour item I10 for “Schedule 2”.

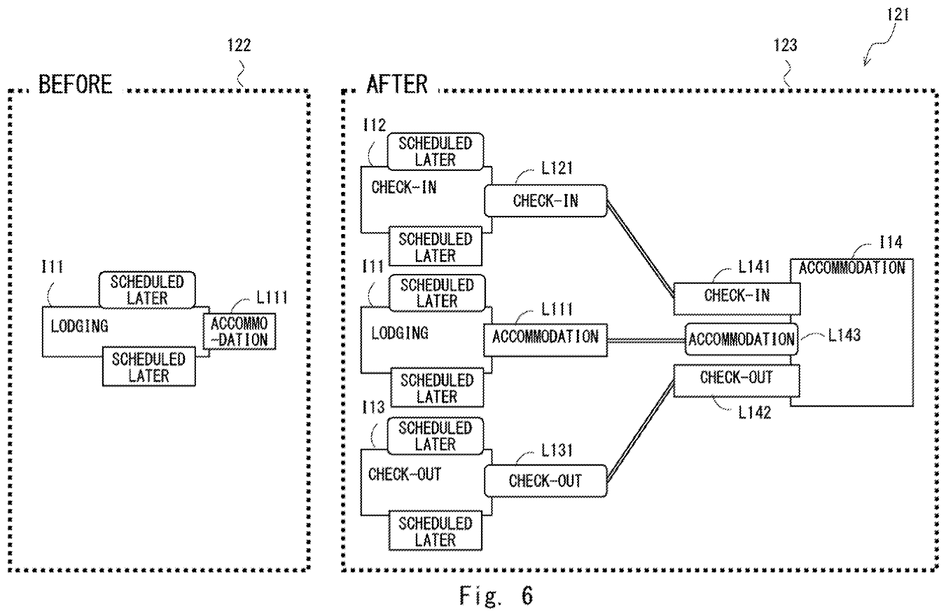

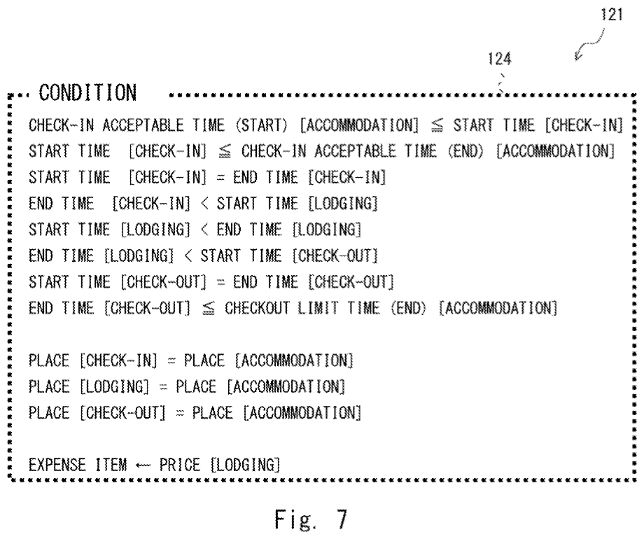

FIG. 6 shows examples of conceptual data structures of the left side 122 and the right side 123 of the concretizing pattern 121 according to a specific example 2, and FIG. 7 shows examples of conceptual data structures of the template 124 of the concretizing pattern 121 according to the specific example 2.

In the concretizing pattern 121 according to the specific example 2 shown in FIGS. 6 and 7, the data structure before the rewriting and that after the rewriting are as follows.

### Data Structure Before Rewriting:

A tour item I11 for “Lodging” is disposed.

Data Structure after Rewriting:

A tour item I12 for “Check-in”, a tour item I13 for “Check-out”, and a tour item I14 for “Accommodation” are added. Note that if the tour item I14 for “Accommodation” is already included in the tour request, the included tour item may be used, so that no new item needs to be added.

Further, a label L111 for “Accommodation” of the tour item I11 for “Lodging” is associated with a label L143 for “Accommodation” of the tour item 114 for “Accommodation”. Further, a label L141 for “Check-in” of the tour item 114 for “Accommodation” is associated with a label L121 for “Check-in” of the tour item I12 for “Check-in”. Further, a label L142 for “Check-out” of the tour item I14 for “Accommodation” is associated with a label L131 for “Check-out” of the tour item I13 for “Check-out”.

FIGS. 8 and 9 show examples of conceptual data structures of a tour request and conditions, respectively, that are obtained by concretizing the tour request and the conditions shown in FIGS. 3 and 4 based on the concretizing patterns 121 according to the specific example 2 shown in FIGS. 6 and 7. In the tour request shown in FIG. 8, the tour request has been rewritten from the left side 122 of the concretizing pattern on the right side 123 thereof. Specifically, a tour item I16 for “Check-in” and a tour item I17 for “Check-out” have been added. Further, a label L61 for “Check-in” of the tour item I6 for “Accommodation” is associated with a label L161 for “Check-in” of the tour item I16 for “Check-in”. Further, a label L62 for “Check-out” of the tour item I6 for “Accommodation” is associated with a label L171 for “Check-out” of the tour item I17 for “Check-out”. Further, conditions generated by the template 124 have been added in the conditions shown in FIG. 9.

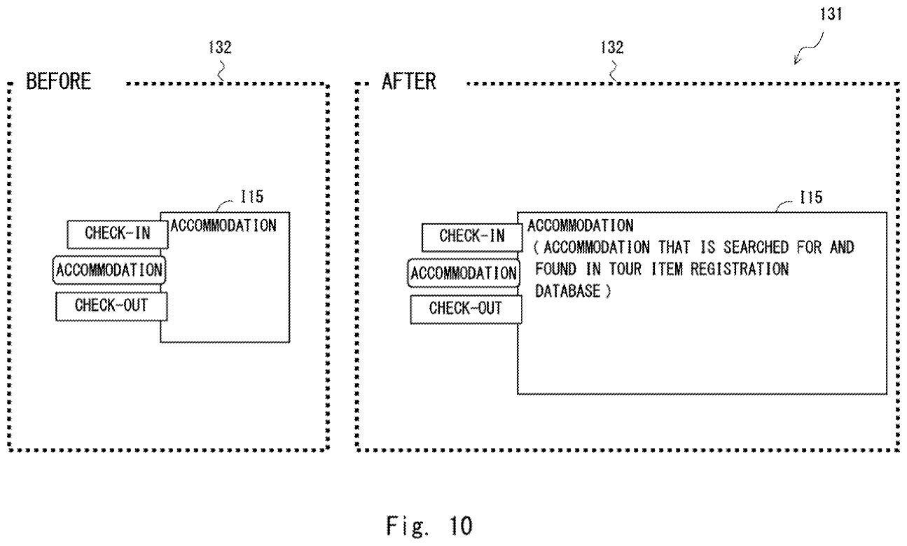

FIG. 10 shows examples of conceptual data structures of a left side 132 and a right side 133 of a concretizing pattern 131 according to a specific example 3. Note that the illustration of the data structure of the template of the concretizing pattern 131 is omitted.

In the concretizing pattern 131 according to the specific example 3 shown in FIG. 10, the data structure before the rewriting and that after the rewriting are as follows.

### Data Structure Before Rewriting:

A tour item I15 for “Accommodation” is disposed. At this point, for the “Accommodation”, only conditions such as a budget, a region, and the like are designated, and other conditions have not yet been concretized.

Data Structure after Rewriting:

Regarding the “Accommodation” in the tour item I15, an accommodation that satisfies the conditions is searched for from the tour item registration database 104 and the “Accommodation” in the tour item I15 is concretized to (i.e., replaced by) the found accommodation.

Therefore, when the tour request concretizing unit 102 uses the concretizing pattern 131 according to the specific example 3, it provides a query including search conditions for an accommodation, such as a budget, a region, and the like, to the tour item registration database 104, and receives a response including an accommodation(s) that satisfies the search conditions from the tour item registration database 104. Note that details of the tour item registration database 104 will be described later.

The tour request concretizing unit 102 concretizes the tour request and the conditions into a structure that includes no undetermined item or the like by repeatedly concretizing undetermined items and the like in the tour request and those in the conditions based on a concretizing pattern like the one described above.

When the tour item registration database 104 receives a query from the tour request concretizing unit 102, it searches for a tour item that satisfies the search conditions included in the query, and returns a response including all or some of found tour items to the tour request concretizing unit 102.

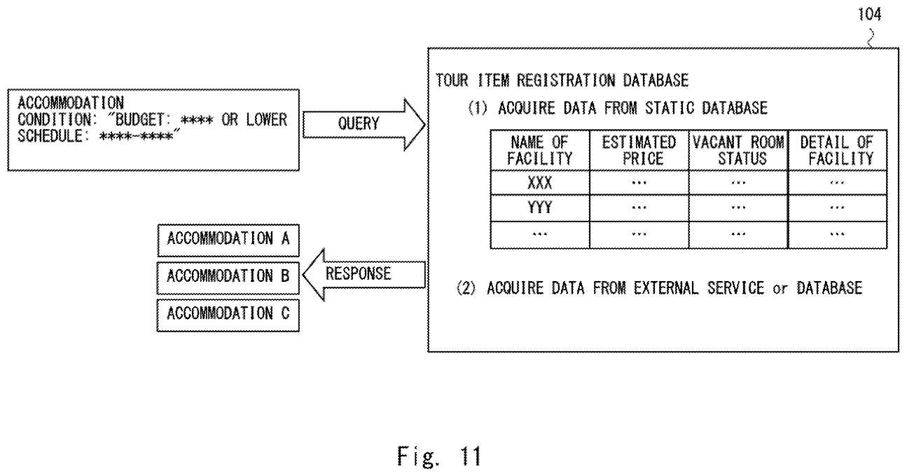

FIG. 11 is a diagram for explaining an example of operations of the tour item registration database 104. FIG. 11 shows an example of operations that are performed when an accommodation is retrieved. In the example shown in FIG. 11, the tour item registration database 104 receives a query including search conditions for an accommodation, such as a budget and a schedule, and returns a response including accommodations A, B and C found by searching. Note that the tour item registration database 104 may include a static database and data may be acquired from the static database, or data may be acquired from dynamic resources. The dynamic resources may be, for example, an external (e.g., outsource) service or an external dynamically-changing database. For example, in the case where data on an accommodation is acquired, the external service may be an accommodation booking service, a private rental home search service, or the like.

Note that the tour request input unit 101 may also use the tour item registration database 104 in order to help a customer to enter data or the like. For example, when a customer enters a budget, a schedule, and the like as a tour request and conditions, the tour request input unit 101 provides a query including these items as search conditions to the tour item registration database 104. As a result, the tour request input unit 101 can obtain data on an accommodation(s) that satisfies the search conditions as a response to the query, so that the tour request input unit 101 may present the accommodation(s) to the customer.

When the tour request concretizing unit 102 concretizes the tour request and the conditions to a structure that includes no undetermined item or the like, it gives the concretized tour request and conditions to the condition verification unit 105 and thereby requests the condition verification unit 105 to verify whether or not the concretized tour request satisfies the concretized conditions.

When the condition verification unit 105 receives the concretized tour request and conditions from the tour request concretizing unit 102, it verifies whether or not the concretized tour request satisfies the concretized conditions, and returns the result of the verification to the tour request concretizing unit 102.

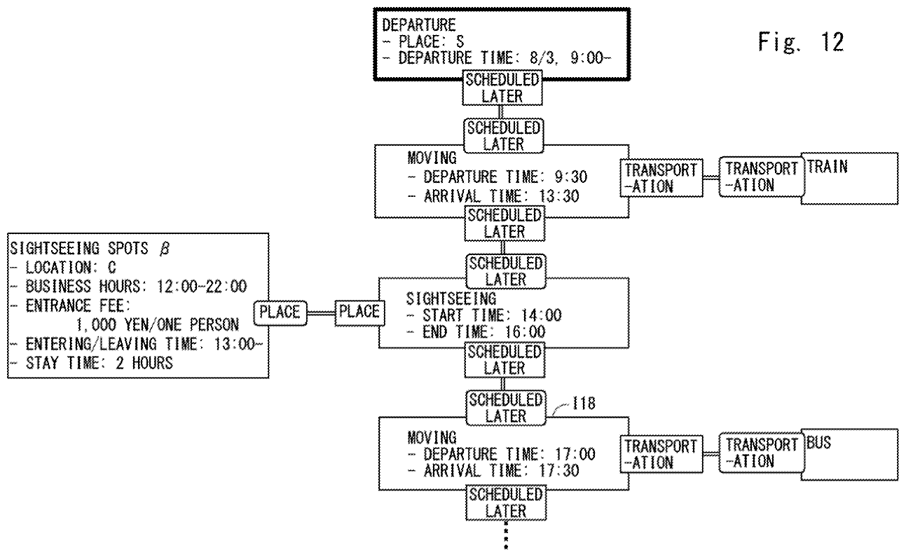

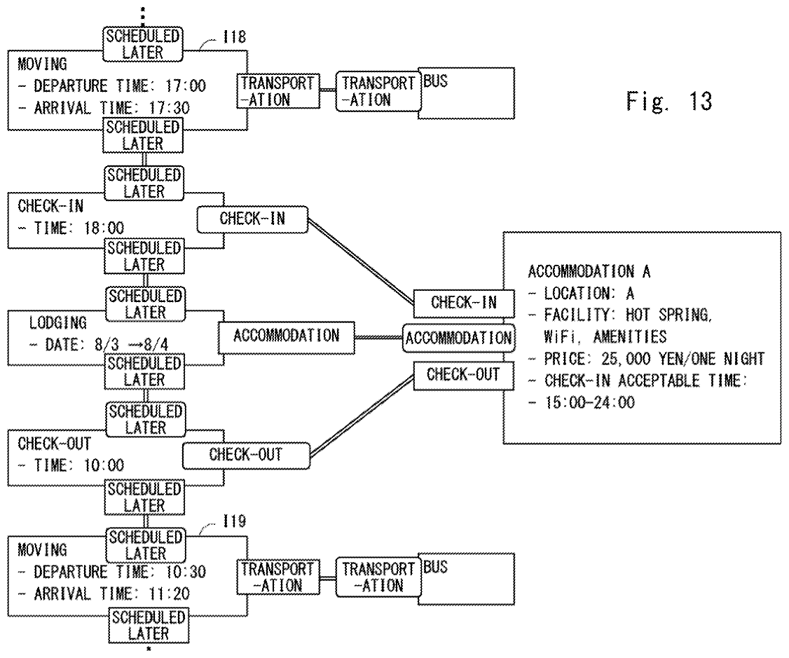

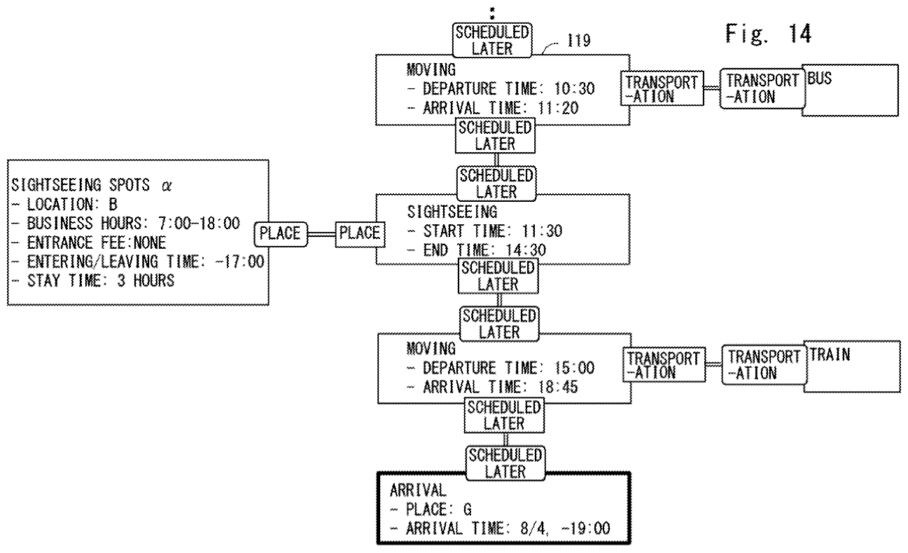

When the concretized tour request satisfies the concretized conditions, the concretized tour request is determined as a tour plan that will be proposed to the customer. FIGS. 12 to 14 show an example of a conceptual data structure of a tour plan that is generated by concretizing the tour request shown in FIG. 3. Note that FIGS. 12 to 14 show one tour plan which is divided into three parts and shown in these three figures. A tour item I18 shown in the bottom of FIG. 12 and a tour item I18 shown in the top of FIG. 13 represent the same tour item, and a tour item I19 shown in the bottom of FIG. 13 and a tour item I19 shown in the top of FIG. 14 represent the same tour item.

The tour plan shown in FIGS. 12 to 14 includes no undetermined item or the like and satisfies the concretized conditions. Details of the tour are roughly as follows.

Depart from a place S
Move by a train
Visit a sightseeing spot β

### Move by a bus

Stay overnight at an accommodation A

### Move by a bus

Visit a sightseeing spot α
Move by a train
Arrive at a place G

The tour plan output unit 106 outputs all or some of the tour plans to the terminal 200 in order to propose them to the customer.

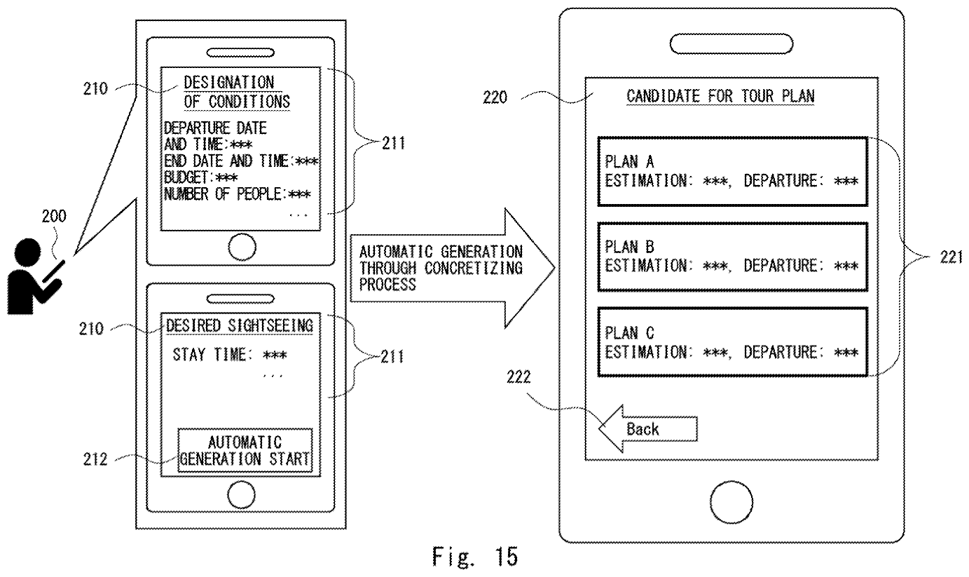

FIG. 15 shows an example of an input window 210 and an output window 220 displayed on a display of a terminal 200 according to the first example embodiment.

The input window 210 is a window that the tour request input unit 101 displays on the display of the terminal 200 when a customer enters a tour request and conditions. The input window 210 includes an area 211 and a button 212. The area 211 is an area where a customer enters a tour request and conditions. Specifically, elements constituting a tour request and conditions are input in the form of text data in the area 211, and the tour request input unit 101 generates the tour request and the conditions as shown in FIGS. 3 and 4 based on the input elements. Note that the elements that the customer enters are not limited to specific names of famous places and events. That is, the customer can input a somewhat indefinite designation such as “a romantic place” or “a facility that can be visited by a budget of xxxx or lower”. That is, the somewhat indefinite designation can be considered to be a designation that includes room for concretization or includes ambiguity. When a somewhat indefinite designation for a famous place or an event is input, it is possible to provide a query including the designation to the tour item registration database 104 and thereby to obtain a specific famous place or a specific event as a response to the query. In this case, the tour request input unit 101 may provide the query when the tour request and the conditions are input, or the tour request concretizing unit 102 may provide it when the tour request and the conditions are concretized.

When the button 212 is operated, the tour request concretizing unit 102 acquires a tour request and conditions generated based on the elements input in the area 211 from the tour request input unit 101, and starts an automatic generation process using a concretizing process to concretize the acquired tour request and conditions.

The output window 220 is a window that the tour plan output unit 106 displays on the display of the terminal 200 after the button 212 is operated. The output window 220 includes an area 221 and a button 222. The area 221 is an area for displaying a list of tour plans generated by the tour request concretizing unit 102. When one of the tour plans displayed in the area 221 is selected, the tour plan output unit 106 displays, on the display of the terminal 200, another output window in which details of the selected tour plan are described. The output window displayed here is, for example, but not limited to, a window in which the tour plan is expressed in a data structure as shown in FIGS. 12 to 14.

When the button 222 is operated, the tour request input unit 101 displays the input window 210 again on the display of the terminal 200. In this way, after checking the details of the tour plan, the customer can edit the tour request and the conditions again.

Note that, in the output window in which the details of the tour plan are described, the customer may be able to order a package tour according to that tour plan. In this case, the tour plan output unit 106 may automatically carry out, among the procedures necessary to carry out the ordered tour plan, procedures that can be automatically carried out. Examples of the procedures that can be automatically carried out include a reservation of an accommodation and a reservation of transportation.

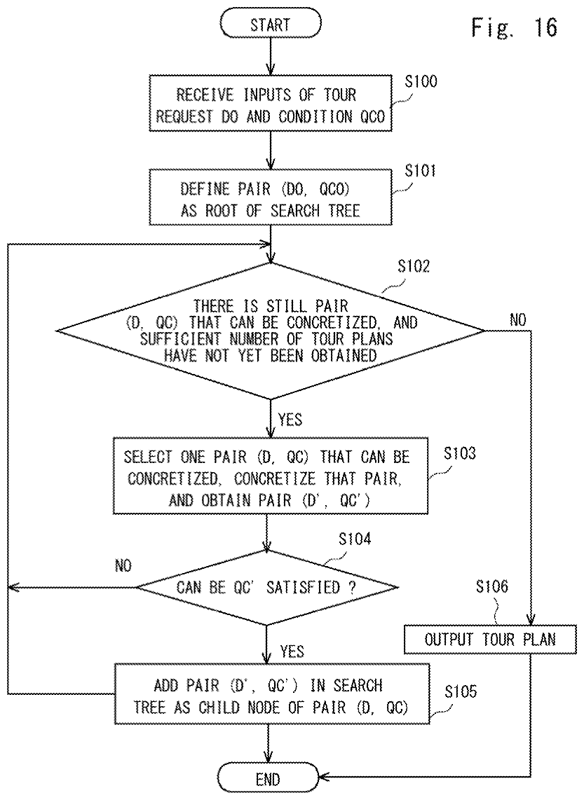

Next, a flow of operations performed by the tour plan generation apparatus 100 according to the first example embodiment will be described. FIG. 16 is a flowchart for explaining an example of a flow of operations performed by the tour plan generation apparatus 100 according to the first example embodiment.

As shown in FIG. 16, firstly, the tour request input unit 101 receives inputs of a tour request and conditions for a package tour (Step S100). The input tour request and conditions are associated with each other.

Hereinafter, a tour request is represented by a sign D and a condition is represented by a sign QC. In particular, a tour request that is input at the start is represented by a sign D0, and a condition(s) that is input at the start is represented by a sign QC0.

Next, the tour request concretizing unit 102 defines a pair of the tour request D0 and the condition QC0 input to the tour request input unit 101 as the root of a search tree (Step S101). In this search tree, a pair of a tour request and a condition(s) is used as a node. Further, a pair of a tour request and a condition(s) may be expressed, for example, as a pair (D, QC).

Next, the tour request concretizing unit 102 determines whether or not a condition that “there is still a pair (D, QC) that can be concretized, and a sufficient number of tour plans have not yet been obtained” is satisfied (Step S102). Note that the pair (D, QC) that can be concretized is a pair of a tour request D and a condition(s) QC associated with that tour request D. Further, the above-described “sufficient number” is determined in advance.

In the step S102, when the above-described condition is satisfied (YES in Step S102), the tour request concretizing unit 102 selects one pair (D, QC) that can be concretized, concretizes that pair (D, QC) based on a concretizing pattern, and thereby obtains a pair (D′, QC′) (Step S103). In the step S103, the tour request concretizing unit 102 generates the tour request D′ and the condition(s) QC′ by concretizing the tour request D and the condition(s) QC, respectively, based on the concretizing pattern.

Note that when the tour request concretizing unit 102 selects one pair (D, QC) that can be concretized in the step S103, it selects, among the pairs (D, QC) included in the search tree, a pair (D, QC) that satisfies a condition that “the tour request D is not completely concretized” and “there is a concretizing pattern that can be applied to an item or the like to be concretized included in the tour request D but has not yet been applied to the item or the like”. Note that, for example, when there are two items or the like to be concretized in the tour request D to which a concretizing pattern can be applied, but the concretizing pattern has been applied to only one of the items or the like to be concretized, the concretizing pattern is handled as a concretizing pattern that has not yet been applied to the item or the like to be concretized in the tour request D.

Next, the tour request concretizing unit 102 provides the tour request D′ and the condition(s) QC′ to the condition verification unit 105, and requests the condition verification unit 105 to verify whether or not the tour request D′ satisfies the condition(s) QC′. The condition verification unit 105 verifies whether or not the tour request D′ satisfies the condition(s) QC′ in response to the request from the tour request concretizing unit 102, and returns the result of the verification to the tour request concretizing unit 102. The tour request concretizing unit 102 determines whether or not the condition(s) QC′ can be satisfied based on the result of the verification (Step S104).

When the condition(s) QC′ can be satisfied in the step S104 (YES in Step S104), the tour request concretizing unit 102 adds the pair (D′, QC′) in the search tree as a child node of the pair (D, QC) selected in the step S103 (Step S105). The tour request D′ in the pair (D′, QC′) added in the search tree becomes one of tour plans that will be proposed to the customer. After the step S105, the tour request concretizing unit 102 returns to the step S102 and repeats the processes in the step S102 and the subsequent steps.

Further, when the condition(s) QC′ cannot be satisfied in the step S104 (NO in Step S104), the tour request concretizing unit 102 moves to the step S102 without performing the step S105, and repeats the processes in the step S102 and the subsequent steps.

Further, in the case where the condition that “there is still a pair (D, QC) that can be concretized, and a sufficient number of tour plans have not yet been obtained” is not satisfied in the step S102 (NO in Step S102), the tour plan output unit 106 outputs the tour plans that have been obtained up to that point (Step S106) and finishes the process. Note that, in the step S106, the tour plan output unit 106 may output all the obtained tour plans, or may output a predetermined number (e.g., one) of the obtained tour plans.

As described above, according to the first example embodiment, the tour request input unit 101 receives inputs of a tour request and conditions for a package tour. The tour request concretizing unit 102 concretizes the input tour request and conditions and thereby generates, as a tour plan, a concretized tour request that satisfies concretized conditions. The tour plan output unit 106 outputs the generated tour plan.

Therefore, it is possible to generate a flexible tour plan that satisfies customer's requests as compared to the technology in which a tour plan is generated by using travel model template data as described in Japanese Unexamined Patent Application Publication No. 2003-044553.

### Second Example Embodiment

In the above-described first example embodiment, a tour plan is generated based on a tour request and conditions for a package tour.

However, there may be cases where, during a tour according to a tour plan, some of tour items included in the tour plan cannot be carried out due to deterioration of weather conditions or an accident such as a delay of transportation, and as a result, it is necessary to make a change to the tour plan.

In a second example embodiment, a tour plan is re-generated when a tour item(s) cannot be carried out due to an accident or the like.

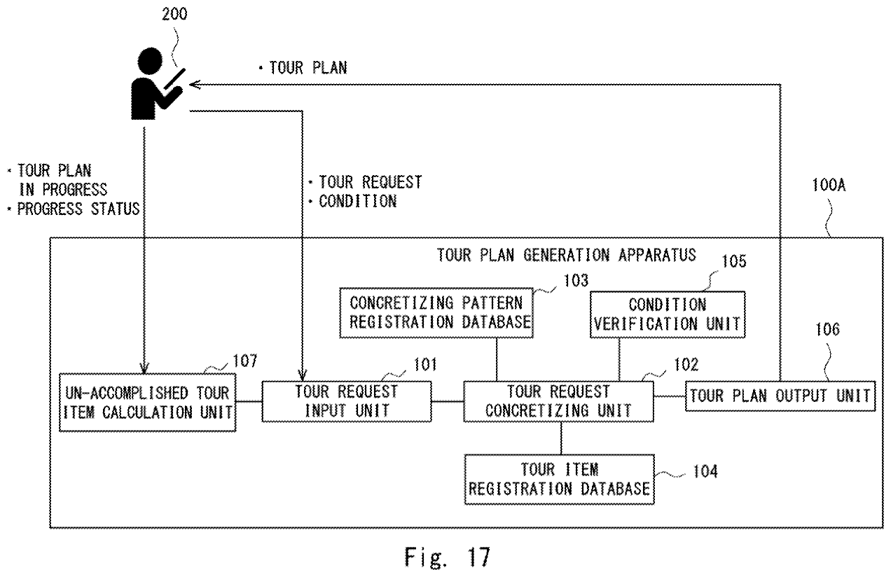

Firstly, an example of a configuration of a tour plan generation apparatus 100A according to the second example embodiment will be described. FIG. 17 shows an example of the configuration of the tour plan generation apparatus 100A according to the second example embodiment. As shown in FIG. 17, the tour plan generation apparatus 100A according to the second example embodiment includes an additional un-accomplished tour item calculation unit 107 as compared to the tour plan generation apparatus 100 according to the above-described first example embodiment.

An example of a modifying process for modifying a tour plan in the tour plan generation apparatus 100A according to the second example embodiment will be described. The following description will be given on the assumption that: a customer has entered a tour request A and conditions, and a tour plan P_{A} has been proposed to the customer by the tour plan generation apparatus 100A; and a modifying process has been started in order to modify the tour plan P_{A} while the tour plan P_{A} is in progress.

### Step S201:

Firstly, the un-accomplished tour item calculation unit 107 receives, from the terminal 200, an input of a progress status indicating a tour plan P_{A} in progress and tour items included in the tour plan P_{A} that have already been carried out. Note that as a method for inputting a progress status, the terminal 200 may use a method in which tour items that have already been carried out are collectively input (notified) when a modifying process is started, or may use a method in which every time a tour item is carried out in accordance with the progress of the tour plan P_{A}, the carried-out tour item is input (notified).

### Step S202:

Next, the un-accomplished tour item calculation unit 107 calculates, among the tour items included in the tour plan P_{A}, un-accomplished tour items that have not yet been carried out based on the progress status of the tour plan P_{A}, and outputs (presents) the calculated tour items to the terminal 200.

### Step S203:

Next, if necessary, the tour request input unit 101 receives, from the terminal 200, inputs of a modified tour request A′ and modified conditions which have been modified based on the un-accomplished tour items. Note that the customer can arbitrarily determine whether or not to modify the tour request A. Further, when the tour request A is modified, the customer can also arbitrarily determine whether or not to modify the conditions along with the tour request A. In this example, it is assumed that the modified tour request A′ and the current (i.e., original) conditions are input.

### Step S204:

After that, the tour request concretizing unit 102 concretizes the tour request A′ and the conditions based on a concretizing pattern. When the concretized tour request A′ satisfies the concretized conditions, the concretized tour request A′ is determined as a tour plan P_{A′}, and the tour plan output unit 106 outputs (presents) the tour plan P_{A′} to the terminal 200.

Next, a modifying process in the tour plan generation apparatus 100A according to the second example embodiment will be described by using a specific example.

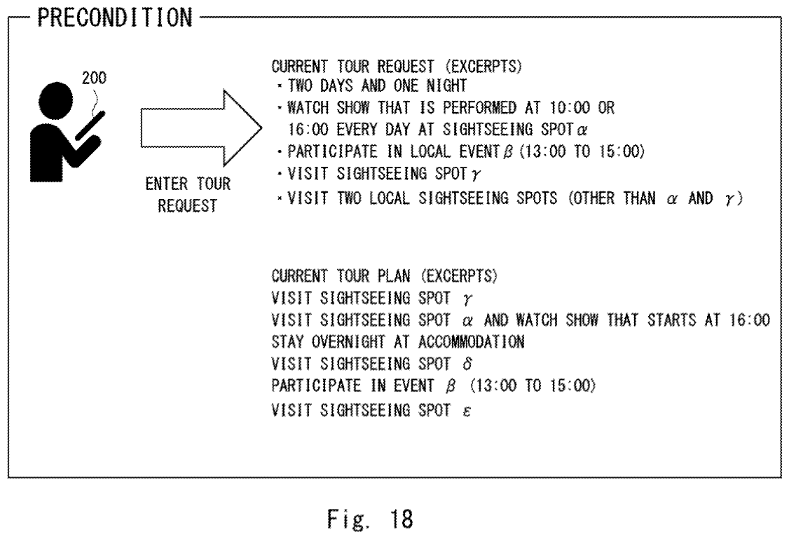

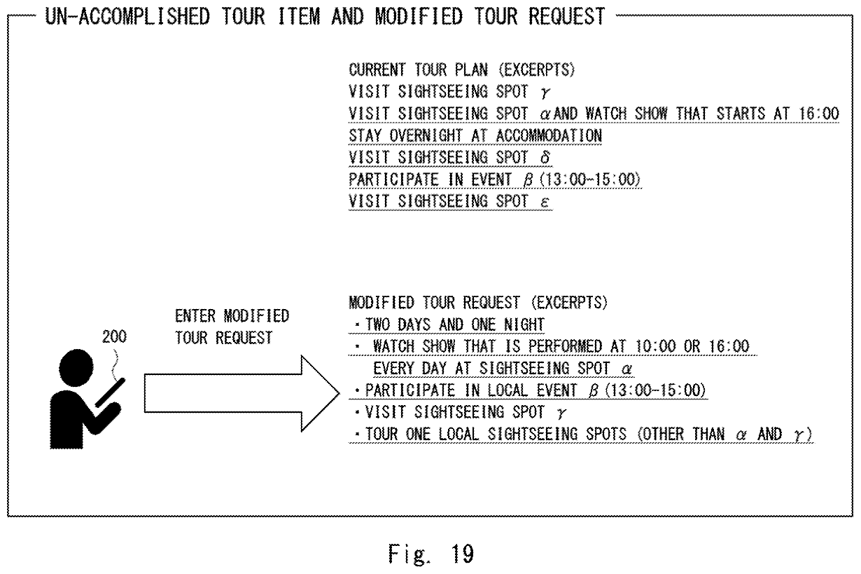

FIG. 18 shows an example of a current tour plan for which a modifying process is performed, and a current tour request based on which the current tour plan has been generated. Note that the tour request and the tour plan shown in FIG. 18 are excerpts. (The same applies to FIGS. 19 to 21 described later.)

The current tour request shown in FIG. 18 is as follows.
Two days and one night
Watch a show that is performed at 10:00 or 16:00 every day at a sightseeing spot α
Participate in a local event β (13:00 to 15:00)
Visit a sightseeing spot γ
Visit two local sightseeing spots (other than the sightseeing spots α and γ)

Further, the current tour plan shown in FIG. 18 is a tour plan that is generated by concretizing the current tour request shown in FIG. 18, and is as follows.

Visit a sightseeing spot γ
Visit a sightseeing spot α and watch a show that starts at 16:00
Stay overnight at an accommodation
Visit a sightseeing spot δ
Participate in an event β (13:00 to 15:00)
Visit a sightseeing spot ε

Here, it is assumed that the customer cannot carry out the tour item that starts at 16:00, i.e., the tour item “Visit a sightseeing spot α and watch a show that starts at 16:00” due to a delay of a train caused by an accident thereof during the tour according to the tour plan shown in FIG. 18.

In this case, the customer starts a modifying process and enters the progress status of the tour plan shown in FIG. 18, and the un-accomplished tour item calculation unit 107 calculates un-accomplished tour items among the tour items included in the tour plan shown in FIG. 18 based on the entered progress status.

FIG. 19 shows an example of the current tour plan, and a modified tour request which has been modified based on tour items of the current tour plan that have not yet been carried out. Note that the un-accomplished tour items among the tour items shown in FIG. 19 are underlined.

The tour plan shown in FIG. 19 is the same as the tour plan shown in FIG. 18. Among the tour items included in the tour plan shown in FIG. 19, the un-accomplished tour items are tour items that are scheduled to be carried out at 16:00 or later, and are as follows.

Visit a sightseeing spot α and watch a show that starts at 16:00
Stay overnight at an accommodation
Visit a sightseeing spot δ
Participate in an event β (13:00 to 15:00)
Visit a sightseeing spot ε
The un-accomplished tour item calculation unit 107 calculates the above-described un-accomplished tour items and outputs (presents) the calculated tour items to the terminal 200.

The customer enters a modified tour request like the one shown in FIG. 19 based on the presented un-accomplished tour items. In the example shown in FIG. 19, the customer has changed “Tour two local sightseeing spots (other than the sightseeing spots α and γ)” to “Tour one local sightseeing spot (other than the sightseeing spots α and γ).

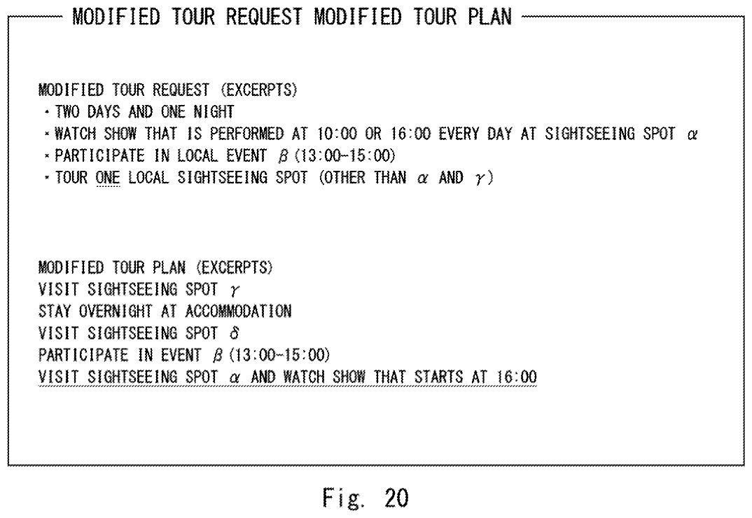

FIG. 20 shows an example of a modified tour request and a modified tour plan that has been re-generated based on the modified tour request. Note that, in the modified tour request and the modified tour plan shown in FIG. 20, parts that have been changed from those in the current tour request (FIG. 19) and the current tour plan (FIG. 19) are underlined.

The modified tour request shown in FIG. 20 is the same as the modified tour request shown in FIG. 19.

The tour request concretizing unit 102 concretizes the modified tour request shown in FIG. 20 together with the conditions based on a concretizing pattern. Note that when there is no change in the conditions, the current conditions may be used, whereas when the conditions have been modified, the modified conditions may be used.

The modified tour plan shown in FIG. 20 is a tour plan that has been re-generated by concretizing the modified tour request shown in FIG. 20.

In the modified tour plan shown in FIG. 20, the parts that have been changed from those in the current tour plan (FIG. 19) are as follows.
Date of “Visit a sightseeing spot α and watch a show that starts at 16:00” is changed to next day
“Visit a sightseeing spot ε” is cancelled.

Note that although the customer enters a modified tour request and a modified tour plan is re-generated based on the modified tour request in the example shown in FIGS. 18 to 20, the modification of the tour request is not absolutely necessary. The modified tour plan may be re-generated based on the current plan request.

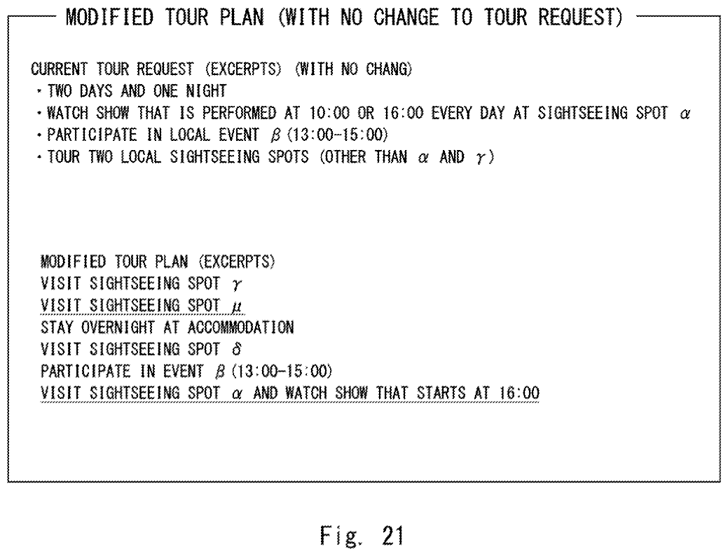

FIG. 21 shows an example of a current tour request, and a modified tour plan that has been re-generated based on the current tour request. Note that, in the modified tour plan shown in FIG. 21, parts that have been changed from those in the current tour plan (FIG. 19) are underlined.

The tour request shown in FIG. 21 is the same as the current tour request shown in FIG. 18.

The tour request concretizing unit 102 re-generates the modified tour plan by concretizing the current tour request shown in FIG. 21 together with the conditions based on a concretizing pattern.

In the modified tour plan shown in FIG. 21, the parts that have been changed from those in the current tour plan (FIG. 19) are as follows.
Date of “Visit a sightseeing spot α and watch a show that starts at 16:00” is changed to next day
“Visit a sightseeing spot μ” is added
“Visit a sightseeing spot ε” is cancelled.

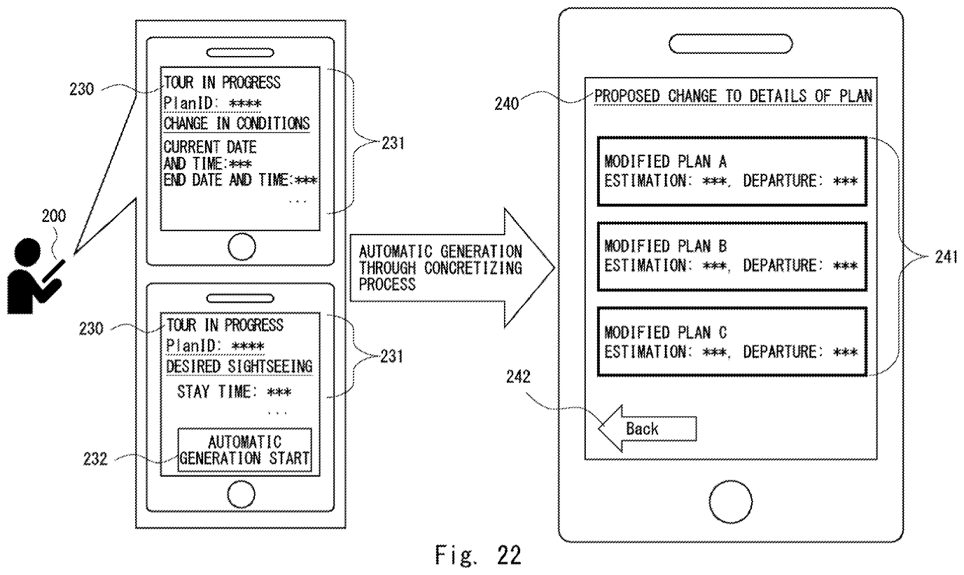

FIG. 22 shows an example of an input window 230 and an output window 240 displayed on a display of a terminal 200 according to the second example embodiment.

The input window 230 is a window that the tour request input unit 101 displays, after un-accomplished tour items are shown in the terminal 200, on the display of the terminal 200 when a customer enters a modified tour request and conditions. The input window 230 includes an area 231 and a button 232. The area 231 is an area where a customer enters a modified tour request and conditions. Specifically, similarly to the area 211 that was described above in the first example embodiment and shown in FIG. 15, elements constituting a modified tour request and conditions are input in the form of text data in the area 231, and the tour request input unit 101 generates the modified tour request and the conditions based on the input elements. Further, similarly to the area 211, the customer can enter a somewhat indefinite designation for a famous place, an event, or the like in the area 231. Further, the method for obtaining a specific famous place and an event when a somewhat indefinite designation is input for a famous place, an event, or the like is similar to that in the above-described first example embodiment.

When the button 232 is operated, the tour request concretizing unit 102 acquires the modified tour request and the conditions generated based on the elements input in the area 231 from the tour request input unit 101, and starts an automatic generation process using a concretizing process to concretize the acquired tour request and conditions.

The output window 240 is a window that the tour plan output unit 106 displays on the display of the terminal 200 after the button 232 is operated. The output window 240 includes an area 241 and a button 242. The area 241 is an area for displaying a list of modified tour plans that have been re-generated by the tour request concretizing unit 102. When one of the tour plans displayed in the area 241 is selected, the tour plan output unit 106 displays another output window in which details of the selected tour plan are shown on the display of the terminal 200. The output window displayed here is, for example, but not limited to, a window in which the tour plan is expressed in a data structure as shown in in FIGS. 12 to 14.

The tour request input unit 101 displays the input window 230 on the display of the terminal 200 again when the button 242 is operated. In this way, after checking the details of the tour plan, the customer can edit the tour request and the conditions again.

Note that, in the tour plan generation apparatus 100A according to the second example embodiment, a flow of operations that are performed when a new tour plan is generated is similar to the flow that was described above in the first example embodiment and shown FIG. 16. Further, a flow of operations that are performed when a modified tour plan is re-generated is also similar to the flow shown FIG. 16, except that the current or modified tour request and conditions are input in the step S100 in FIG. 16.

Therefore, the descriptions of the flow of operations that are performed when a new tour plan is generated and the flow of operations that are performed when a modified tour plan is re-generated in the tour plan generation apparatus 100A according to the second example embodiment are omitted.

As described above, according to the second example embodiment, the un-accomplished tour item calculation unit 107 calculates un-accomplished tour items among the tour items included in the tour plan. The tour request input unit 101 receives inputs of a modified tour request and conditions that have been modified based on the un-accomplished tour items. The tour request concretizing unit 102 concretizes the input modified tour request and the conditions and thereby re-generates, as a modified tour plan, a modified and concretized tour request that satisfies concretized conditions. The tour plan output unit 106 outputs the re-generated tour plan.

Note that the tour request concretizing unit 102 may concretize an already-input tour request and conditions and thereby re-generate, as a modified tour plan, a concretized tour request that satisfies concretized conditions.

Therefore, when a tour item cannot be carried out due to an accident or the like, a tour plan can be re-generated.

Other advantageous effects are similar to those in the above-described first example embodiment.

### Third Example Embodiment

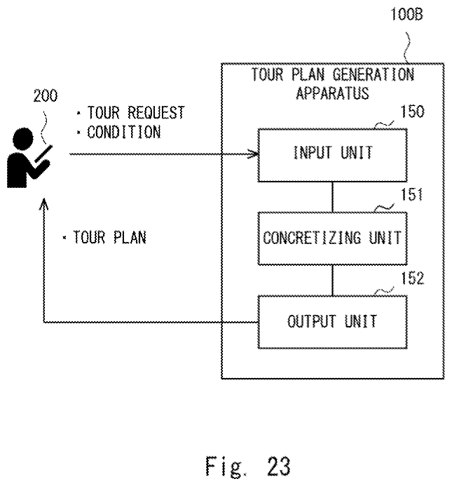

FIG. 23 shows an example of a configuration of a tour plan generation apparatus 100B according to a third example embodiment. As shown in FIG. 23, the tour plan generation apparatus 100B according to the third example embodiment includes an input unit 150, a concretizing unit 151, and an output unit 152.

The input unit 150 receives inputs of a tour request and conditions for a package tour from the terminal 200. The input unit 150 corresponds to, for example, the tour request input unit 101.

The concretizing unit 151 concretizes the input tour request and conditions and thereby generates, as a tour plan, a concretized tour request that satisfies concretized conditions. The concretizing unit 151 corresponds to, for example, the tour request concretizing unit 102.

The output unit 152 outputs the generated tour plan to the terminal 200. The output unit 152 corresponds to, for example, the tour plan output unit 106.

Therefore, it is possible to generate a flexible tour plan that satisfies customer's requests as compared to the technology in which a tour plan is generated by using travel model template data as described in Japanese Unexamined Patent Application Publication No. 2003-044553.

Further, the tour plan generation apparatus 100B according to the third example embodiment may further include a concretizing pattern registration unit in which concretizing patterns, which are patterns for concretizing tour requests and conditions, are registered in advance. The concretizing pattern registration unit corresponds to, for example, the concretizing pattern registration database 103. Further, the concretizing unit 151 may concretize the input tour request and conditions based on a concretizing pattern.

Further, the tour plan generation apparatus 100B according to the third example embodiment may further include a condition verification unit that verifies whether or not a concretized tour request satisfies concretized conditions. The condition verification unit corresponds to, for example, the condition verification unit 105. Further, the concretizing unit 151 may inquire, to the above-described condition verification unit, whether the concretized tour request satisfies the concretized conditions by providing the concretized tour request and the concretized conditions to the above-described condition verification unit.

Further, the tour request and the tour plan may include at least one tour item.

Further, the tour plan generation apparatus 100B according to the third example embodiment may further include a tour item registration unit in which tour items are registered in advance. The tour item registration unit corresponds to, for example, the tour item registration database 104. Further, the concretizing patterns may include a pattern for rewriting a tour item included in a tour request into a tour item registered in the tour item registration unit.

Further, the tour plan generation apparatus 100B according to the third example embodiment may further include a calculation unit that calculates, among tour items included in the tour plan, un-accomplished tour items that have not yet been carried out. The calculation unit corresponds to, for example, the un-accomplished tour item calculation unit 107. Further, the input unit 150 may receive, from the terminal 200, inputs of a modified tour request and conditions that have been modified based on un-accomplished tour items. Further, the concretizing unit 151 may concretize an input modified tour request and conditions, and thereby re-generate, as a modified tour plan, a modified and concretized tour request that satisfies concretized conditions. Further, the output unit 152 may output the re-generated modified tour plan to the terminal 200.

Further, the concretizing unit 151 may concretize an already-input tour request and conditions and thereby re-generate, as a modified tour plan, a concretized tour request that satisfies concretized conditions. Further, the output unit 152 may output the re-generated modified tour plan to the terminal 200.

### Fourth Example Embodiment

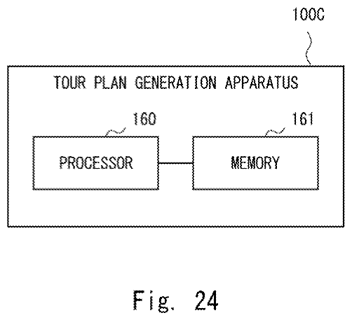

FIG. 24 is a block diagram showing an example of a hardware configuration of a tour plan generation apparatus 100C according to a fourth example embodiment. As shown in FIG. 24, the tour plan generation apparatus 100C according to the fourth example embodiment includes a processor 160 and a memory 161. Note that the illustration of the terminal 200 is omitted in FIG. 24.

The processor 160 may be, for example, a microprocessor, an MPU (Micro Processing Unit), or a CPU (Central Processing Unit). The processor 160 may include a plurality of processors.

The memory 161 is composed of a combination of a volatile memory and a non-volatile memory. The memory 161 may include a storage that is disposed remotely from the processor 160. In this case, the processor 160 may access the memory 161 through an I/O (Input/Output) interface (not shown).

Each of the tour plan generation apparatuses 100, 100A and 100B according to the first, second and third example embodiments, respectively, may have a hardware configuration shown in FIG. 24. The tour request input unit 101, the tour request concretizing unit 102, the condition verification unit 105, the tour plan output unit 106, the un-accomplished tour item calculation unit 107, the input unit 150, the concretizing unit 151, and the output unit 152 in the above-described tour plan generation apparatus 100, 100A and 100B may be implemented by having the processor 160 load a program(s) stored in the memory 161 and execute the loaded program(s). Further, the concretizing pattern registration database 103 and the tour item registration database 104 in the above-described tour plan generation apparatus 100 and 100A may be implemented by the memory 161.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Although the present disclosure is explained above with reference to example embodiments, the present disclosure is not limited to the above-described example embodiments. Various modifications that can be understood by those skilled in the art can be made to the configuration and details of the present disclosure within the scope of the disclosure.

The first to fourth embodiments can be combined as desirable by one of ordinary skill in the art.

What is claimed is:

1. A tour plan generation apparatus comprising:
an input unit configured to receive inputs of a tour request and a condition for a package tour;
a concretizing unit configured to generate, as a tour plan, a concretized tour request by concretizing the input tour request and the condition, the concretized tour request being a request that satisfies the concretized condition; and
an output unit configured to output the generated tour plan.

2. The tour plan generation apparatus according to claim 1, further comprising a concretizing pattern registration unit in which a concretizing pattern is registered in advance, the concretizing pattern being a pattern for concretizing the tour request and the condition, wherein
the concretizing unit concretizes the input tour request and the condition based on the concretizing pattern.

3. The tour plan generation apparatus according to claim 2, further comprising a condition verification unit configured to verify whether or not the concretized tour request satisfies the concretized condition, wherein
the concretizing unit provides the concretized tour request and the concretized condition to the condition verification unit, and thereby inquires, to the condition verification unit, whether the concretized tour request satisfies the concretized condition.

4. The tour plan generation apparatus according to claim 2, wherein the tour request and the tour plan include at least one tour item.

5. The tour plan generation apparatus according to claim 4, further comprising a tour item registration unit in which the tour item is registered in advance, wherein
the concretizing pattern includes a pattern for rewriting the tour item included in the tour request into the tour item registered in the tour item registration unit.

6. The tour plan generation apparatus according to claim 4, further comprising a calculation unit configured to calculate, among tour items included in the tour plan, an un-accomplished tour item that has not yet been carried out, wherein
the input unit receives an input of the modified tour request and the condition that have been modified based on the un-accomplished tour item,
the concretizing unit concretizes the input modified tour request and the condition, and thereby re-generates, as the modified tour plan, the modified and concretized tour request that satisfies the concretized condition, and
the output unit outputs the re-generated modified tour plan.

7. The tour plan generation apparatus according to claim 4, wherein
the concretizing unit concretizes the input tour request and the condition, and thereby re-generates, as the modified tour plan, the concretized tour request that satisfies the concretized condition, and
the output unit outputs the re-generated modified tour plan.

8. A tour plan generation method performed by a tour plan generation apparatus, comprising:
receiving inputs of a tour request and a condition for a package tour;
generating, as a tour plan, a concretized tour request by concretizing the input tour request and the condition, the concretized tour request being a request that satisfies the concretized condition; and
outputting the generated tour plan.

9. A non-transitory computer readable medium storing a program for causing a computer to perform:
a process for receiving inputs of a tour request and a condition for a package tour;
a process for generating, as a tour plan, a concretized tour request by concretizing the input tour request and the condition, the concretized tour request being a request that satisfies the concretized condition; and
a process for outputting the generated tour plan.
